(19) United States
(12) Patent Application Publication
(10) Pub. No.: US 2007/0070040 A1
(43) Pub. Date: Mar. 29, 2007

(54) Product of computer peripheral designed based on ergonomics and fabricating method thereof

(75) Inventors: Chun-Hung Chen, Taipei Hsien (TW); Ming-Chao Lee, Taipei Hsien (TW); Ming-Feng Hsieh, Taipei Hsien (TW); I-Hsuan Chu, Taipei Hsien (TW); Tai - Kuo Wang, Taipei Hsien (TW)

Correspondence Address: BRUCE H. TROXELL;SUITE 1404, 5205 LEESBURG PIKE, FALLS CHURCH, VA, 22041, US

(73) Assignee: AOPEN INC.

(21) Appl. No.: 11/331,279

(22) Filed: Jan. 13, 2006

(30) Foreign Application Priority Data
Aug. 30, 2005 (TW) 094129794

(51) Int. Cl. G09G 5/08

(52) U.S. Cl. 345/161

(57) ABSTRACT

A product of computer peripheral designed based on ergonomics and fabricating method thereof is to integrate all components of the computer system based on ergonomic analysis and the system housing design of the computer. The integration of the components can be done with screening the portable storage media device and the keyboard in the components required and feasible for integration based on affirmed criterion before integrating as an integral ergonomic component is performed such that the computer system and the product of computer peripheral are operated by the user easily and it is favorable for development of enhancing function of the system housing.

### BACKGROUND OF THE INVENTION

1. Field of the Invention

The present invention is related to a product of computer peripheral and particularly to a product of computer peripheral designed based on ergonomics and fabricating method thereof.

2. Brief Description of Related Art

Currently, electronic products are developed to approach lightness, thinness, shortness and smallness for performing multiple works. But, for products with human-machine interface, which plays a bridge for data transmission between the user and personal computer, such as the monitor, the keyboard and the mouse, minimization doesn't mean convenience. The compact disk (burned disk) offers interface with similar function of communication too.

Referring to FIG. 1, the conventional personal computer, taking the desktop computer as an example, includes a system housing 11, a monitor 12, a keyboard 13 and a mouse 14. Usually, the power supply, the optical drive 111 and the card reader or the floppy drive 112 are attached to the system housing 11. Some other computer systems have the system housing 11 thereof externally connecting with the optical drive 15 or card reader 16 instead.

Referring to FIG. 2, while the conventional computer is in use, the system microprocessor 113 performs information transmission with the keyboard 13, the mouse 14, the portable storage media device 17, sound capture/output device 18, the monitor 12 and the image capture device 19 respectively via the system interface/bus 114, the sound card 115, the VGA card 116 and the image processing card 117 and performs information transmission with mass storage device (hard disk) 118. A computer system with both the desktop personal computer and the laptop computer mostly applies the same concept as or similar to the preceding information transmission structure. Of course, there are some of the components integrating two kinds of functions such as the monitor integrating with loudspeaker, the optical drive integrating the card reader and the monitor integrating with the system housing.

Referring to FIG. 3, the conventional desktop computer system is composed of a system housing 20 and human-machine interface 30.

The system housing 20 includes a central processing unit 21, a main board 22, a stationary storage device/hard disk 23, a portable storage media device 24, a memory 25, a sound card 26 and a VGA card 27.

The portable storage media device 24 further includes an optical drive, a floppy drive, a card reader and magnetic optical drive (MO). The human-machine interface 30 further includes a monitor, a sound capture/output device, a mouse, a keyboard and an external device. The external device includes an externally connected optical drive and card reader. From point of view of human-machine interface 30, part of the portable storage media device 24 is placed in the system housing 20.

Under the structure, the system housing 20 is forced to carry out function with user's operation interface. Hence, volume of the system housing 20 and location thereof are limited inevitably.

Taiwanese Utility Model No. M240597 discloses a keyboard type computer with heat dissipation structure,. which includes a standard keyboard with a built-in personal computer and a system heat dissipation device compatible with the special structure. The prior art includes a main board, universal input/output interface with terminals integrated in the main board, Hi-Fi loudspeaker, floppy drive, optical drive, power supply device and expanded card interface for meeting requirement of maintaining high cooling efficiency in a small space.

The main board of the preceding prior art being received in the casing of the keyboard such that sizes of electronic components therein and space for heat dissipation have to be limited inevitably. However, it is unfavorable for development of enhancing function of the main board.

U.S. Pat. No. 6,035,214 discloses a laptop computer associated with a telephone for creating ergonomic physical interface more naturally between the telephone set and the laptop computer. U.S. Pat. No. 6,035,214 has added ergonomic design in computer system to allow the computer system complying with human engineering for the user being able to operate the computer system conveniently.

### SUMMARY OF THE INVENTION

The crux of the present invention is to involve the ergonomic design in a computer system and computer peripheral such that the user is able to use the computer system and the peripheral conveniently for being favorable for enhancing development of system housing of the computer.

An object of the present invention is to provide a product of computer peripheral design based on ergonomics and fabricating method thereof with which space of the system unit can be designed flexibly instead of being limited with operational space of human body such as area of desktop so that performance of the computer is not affected by size of the main board and space of heat dissipation being obliged to reduce done in the prior art.

Another object of the present invention is to provide a product of computer peripheral design based on ergonomics and fabricating method thereof for the user operating information transmission between the computer peripheral product and the computer easily without moving his body.

A further object of the present invention is to provide a product of computer peripheral designed based on ergonomics and fabricating method thereof for the user arranging space on a work platform more flexibly so as to eliminate requirement of the system housing being placed on the desktop.

### BRIEF DESCRIPTION OF THE DRAWINGS

The present invention can be more fully understood by reference to the following description and accompanying drawings, in which:

FIG. 1 is a perspective view illustrating major components of a conventional computer system;

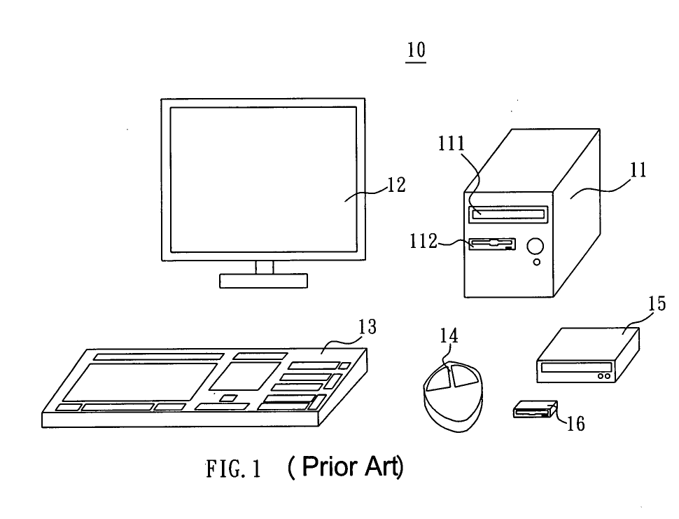

FIG. 2 is a block diagram illustrating data transmission of the conventional computer in use;

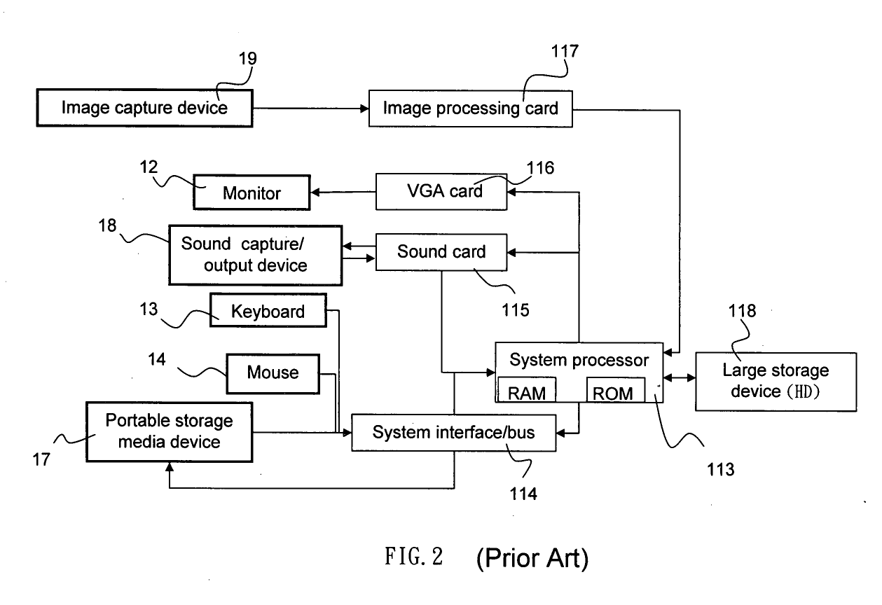

FIG. 3 is a block diagram illustrating arrangement and connection between all components of a conventional desktop computer;

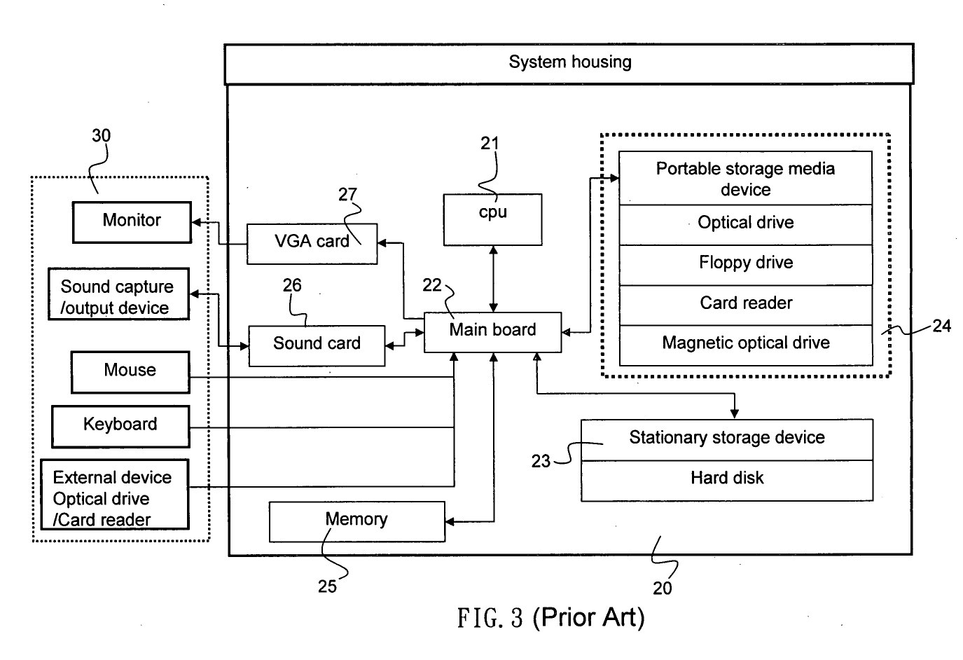

FIG. 4 is a block diagram illustrating arrangement of components of a computer system in which human-machine interfaces being separated from other components according to the present invention;

FIG. 5 is a top view illustrating an ideal operation zone applying ergonomic analysis;

FIG. 6 is a flow chart of a fabricating method according to the present invention;

FIG. 7 is a schematic diagram of space arrangement for ergonomic component and system housing according to the present invention;

FIG. 8 is a block diagram illustrating functional structure of an embodiment for an integrated product according to the present invention;

FIG. 9 is a block diagram illustrating functional structure of another embodiment for an integrated product according to the present invention;

FIG. 10 is a block diagram illustrating functional structure of an embodiment of an actual product after being integrated according to the present invention; and

FIG. 11 is a perspective view illustrating the embodiment for an actual product after being integrated according to the present invention.

### DETAILED DESCRIPTION OF THE INVENTION

Currently developed and popularly used portable storage media have 12 cm, 8 cm compact disk, floppy disk, memory card and flash memory card. From stand points of user's eyes, ears and hands and product size (area and volume) considering feature of product, the storage parts meeting specific conditions such as compact disk drive (disk burner) being integrated placed in several specific parts on the desktop not only is helpful for cost reduction and application of space but also enhances convenience for the user. It is not necessary to move the system housing onto the desk in order to be favorable for the user. Or it is not necessary that an improperly large system housing is moved onto the desk and the compact disk has to be placed in or picked up under the desk just because of consideration of functionality.

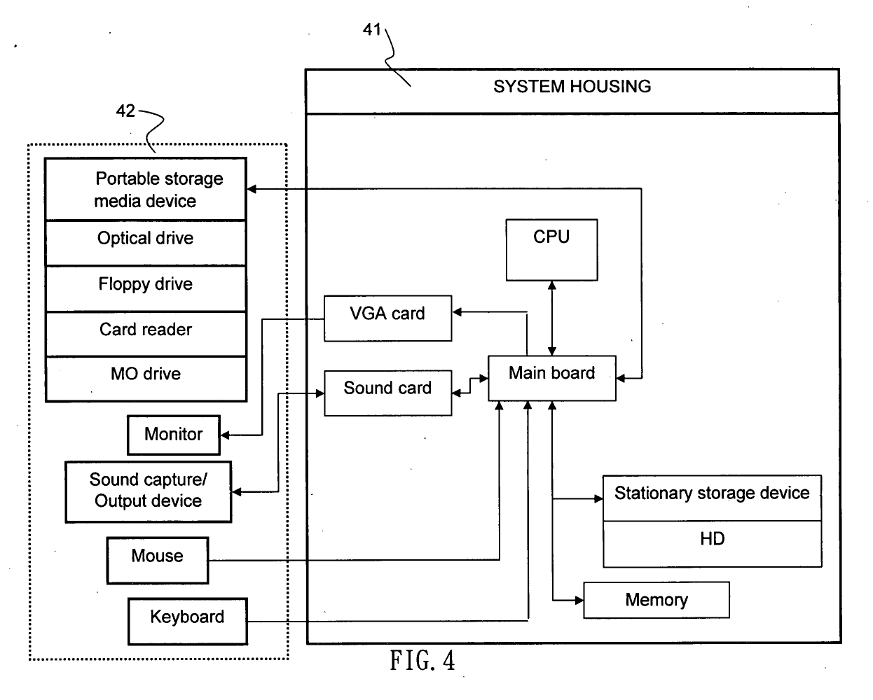

Referring to FIG. 4, if the system housing 41 of a computer is separated from human-machine interface 42, the functional components of the computer can be arranged as the human-machine interface, which is operated by the user frequently, is independent of the system housing 41 such that system housing 41 is capable of being designed more flexibly with consideration of performance and cost instead of being restricted to use limited space on the work platform. In addition, the human-machine interface 42 needs to be further integrated to facilitate the user in operation. The human-machine interface 42 includes portable storage media device, monitor, sound input/output device, mouse and keyboard.

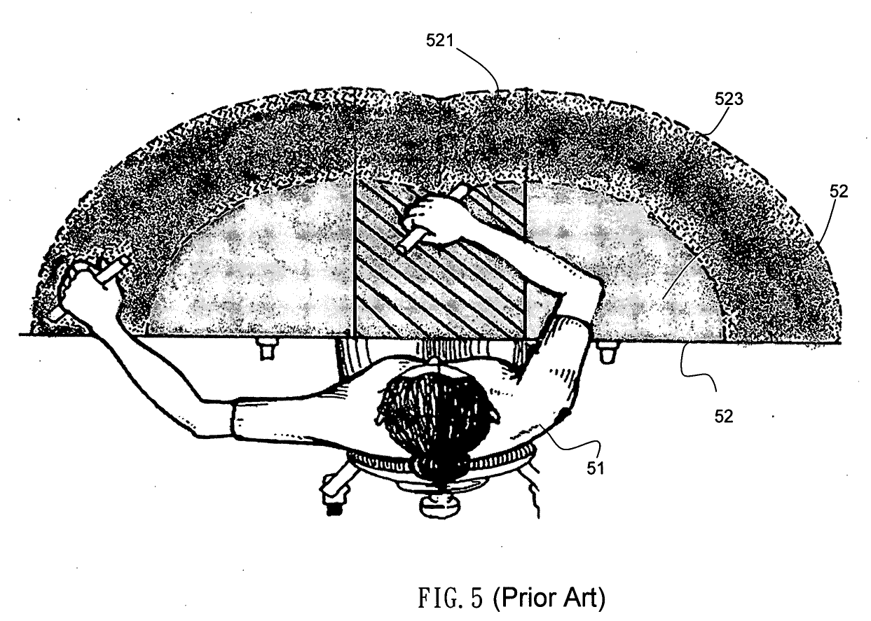

Referring to FIG. 5, the ergonomic analysis is applied to divide operation zone of hands on the desk 52 into an optimum operation zone 521, two primary operation zones 522 and two secondary operation zones 523. The optimum operation zone 521 is in front of the user with a width of 30 cm, which is about the same as the shoulder of the user, and it is within a distance to left and right elbows about 40 cm. This is a best area available for movements with both hands. The primary operation zones 522 are disposed next to two lateral sides of the optimum operation zone 521 respectively within a distance 40 cm from the respective elbow and they are areas available for hands moving conveniently. The secondary operation zones 523 are disposed outside the primary operation zones 522 within a distance about 80 cm from the elbows respectively and they are areas possibly reached by two hands.

The point of the present invention is to integrate the human-machine interface components. Due to the preceding ergonomic analysis and design of the system housing, integration of the components in the computer system can be done with picking out components, which are required and feasible to integrate, based on criterion before the integration is performed.

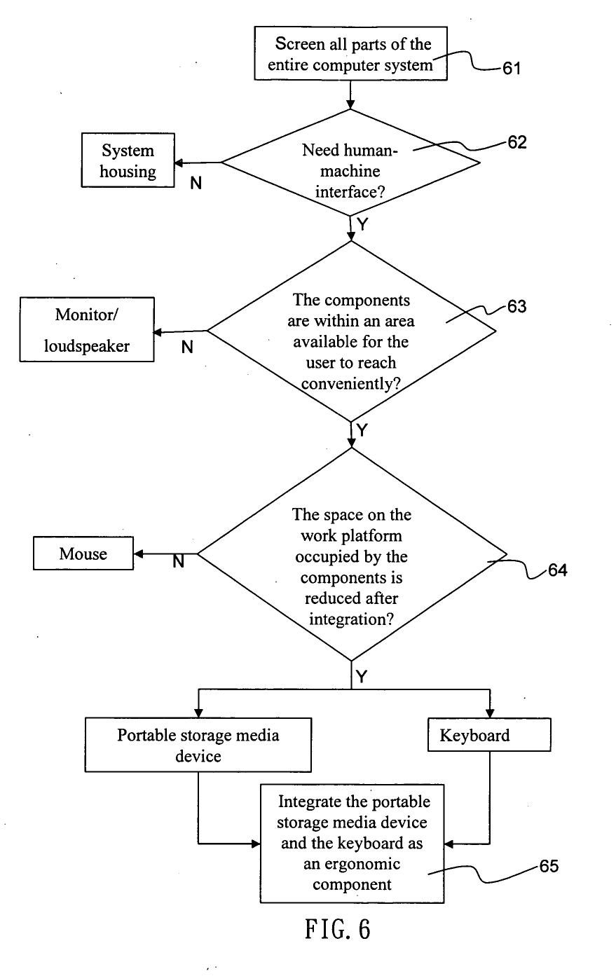

Referring to FIG. 6, a fabricating method for a product of computer peripheral capable of complying with the ergonomic design according the present invention includes following steps:

Step 61 is to screen all parts of the entire computer system.

Step 62 is to affirm if all the components in the computer system need human-machine interface? The system housing is excluded according to the criterion;

Step 63 is to affirm if the components are within an area available for the user to reach conveniently? The monitor and the speaker are excluded according to the criterion.

Step 64 is to affirm if the space on the work platform occupied by the components can be reduced after they are integrated? The mouse is excludes according to the criterion and the portable storage media device such as the compact disk drive, the card reader or the floppy drive and the keyboard are screened.

Step 65 is to integrate the portable storage media device and the keyboard.

There is no priority between preceding steps 62, 63 and 64.

Because operation for performing data transmission is not necessary to join with the system housing, the system housing is capable of having more available space. It is affirmed that the human-machine interface is not required to join with the system housing.

As for affirming if the components are within the area the user can reach conveniently, the optimum operation zone shown in FIG. 5 is selected as a reference. Transmission of data with regard to image and sound is not necessary to operate with body contact such that the monitor and the loudspeaker can be placed a little far away the user in case of the user is able to watch the image in the monitor and hear the sound from the speaker clearly. Hence, both the monitor and the loudspeaker do not fulfill requirement of integration of the invention. As the foregoing, integrated product with regard to the monitor and the loudspeaker is different from the present invention.

Many externally connected optical drives available on the market have integrated with card readers. But, It doesn't mean this is an application of the present invention, which emphasizes that integration of different components can reduce occupied space on the work platform effectively. Due to the keyboard being a major integrated component according to the present invention, the occupied space on the work platform can be reduced in accordance with the criterion. Another reason for excluding the mouse is operating the mouse needs a flexible space in practice in spite of hardware space providing possibility for integration.

The integrated human-machine interface such as portable storage device integrated as an ergonomic component to distinguish from other different integrated components. The keyboard is utilized in the present invention to integrate with components needing human-machine interface because the keyboard provides a feature that the size thereof is unable to reduce excessively for being able to be operated by the user. In this way, it is different from current product and has better effect.

The greatest facial side of keyboard mentioned in the present invention has to be greater than the area of a circle with a diameter 12 cm. Small input device, which provides only digital input or simple mathematic operations such as +, −, × and ÷ or small input device, which provides specific function, is not included in the scope of integration done in the present invention.

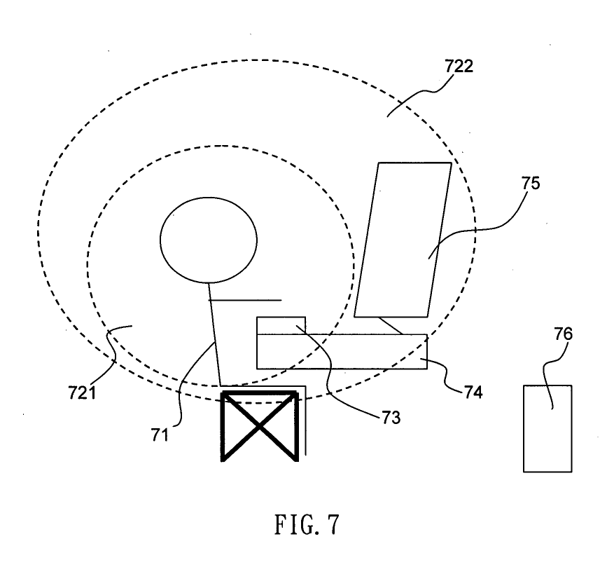

Referring to FIG. 7, space arrangement of the human factor and system main unit can be divided as an operational zone 721 and a sight zone 722 based on operation extent of the user 71. The ergonomic component 73 can be placed on the desktop 74 within the operational zone 721 of the user 71. The monitor 75 can be placed on the desktop 74 within sight zone 722 of the user 71. The system housing 76, which provides no function of human machine interface, can be placed outside the sight zone 722. In this way, limited operational space, especially the desktop 74, can be arranged to use more effectively. Once the system housing 76 is not restricted by the operational space, the volume thereof can be considered from the standpoint of function and cost. After all, size of the system influences specifications of all components.

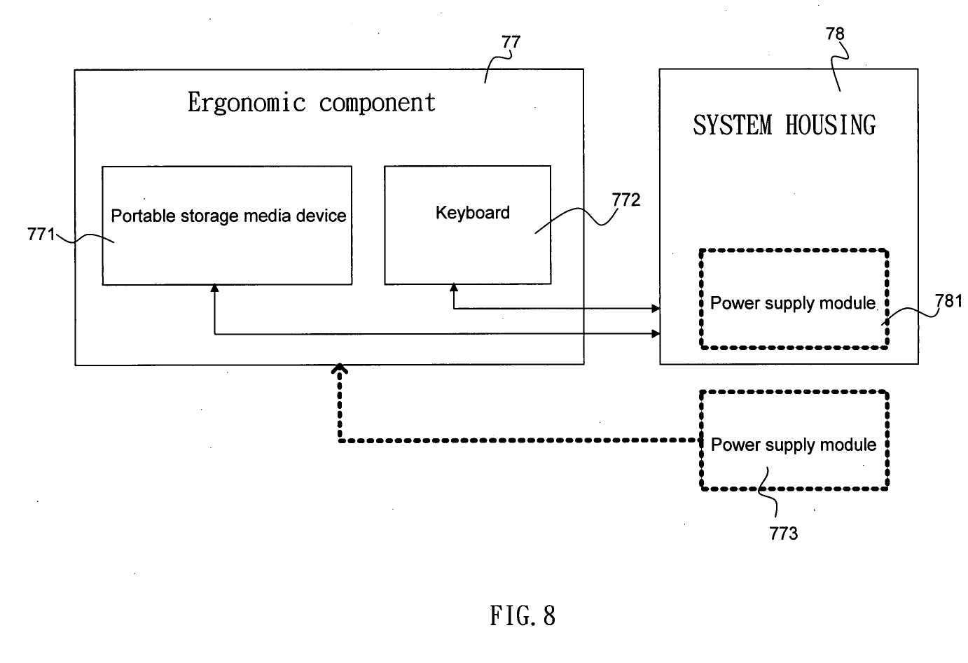

Referring to FIG. 8, an embodiment of the product, which is integrated from the portable storage media device 771 and the keyboard 772, which are designated as an ergonomic component 77 in the present invention, is illustrated. A power supply module 773 supplies power required by the ergonomic component 77. The portable storage media device 771 and the keyboard 772 electrically connect with the system housing 78 respectively for transmitting messages. The power supply module 781 supplies power by the system housing 78.

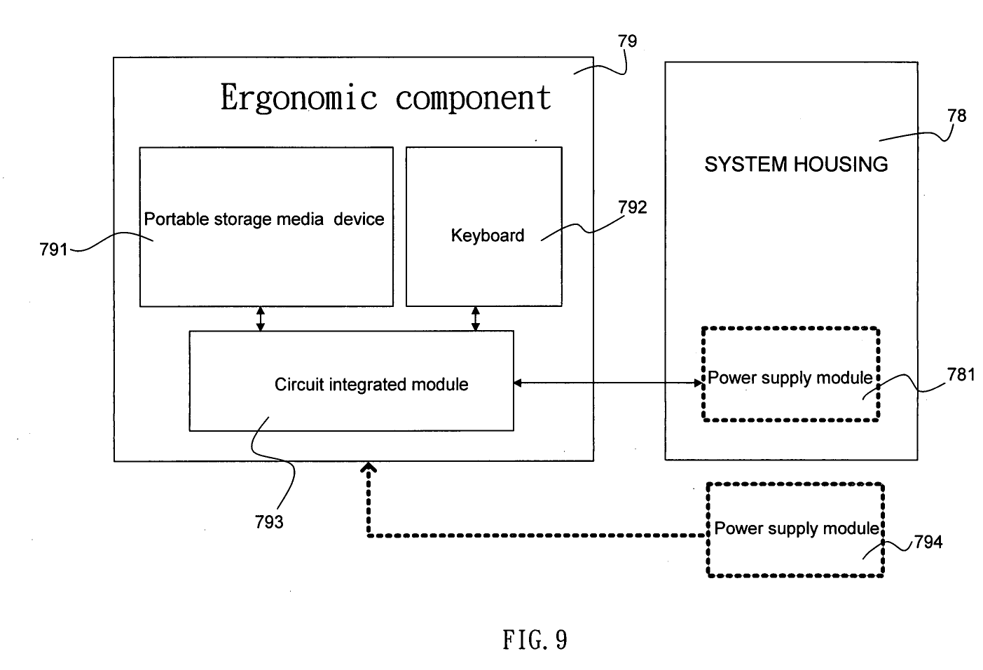

Referring to FIG. 9, another embodiment of ergonomic component 79 is illustrated. The portable storage media device 791 and the keyboard 772 electrically connect with a circuit integration module 793. The power supply module 794 supplies power required by the ergonomic component 79. The circuit integration module 793 electrically connects with the system housing 78 to allow message transmission between the portable storage media device 791 and the system housing 78 and between the keyboard 792 and the system housing 78 respectively.

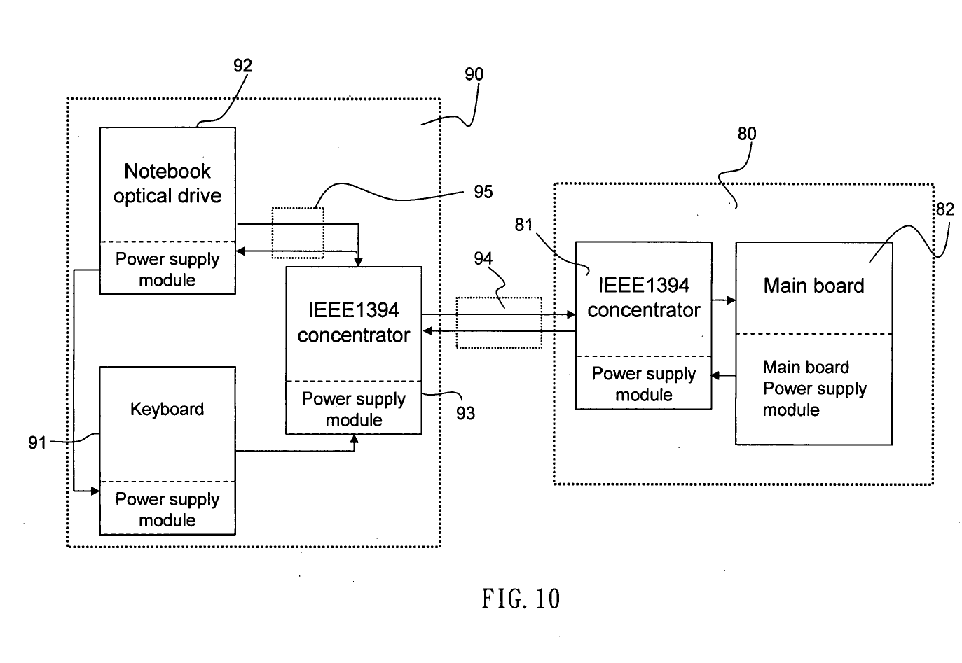

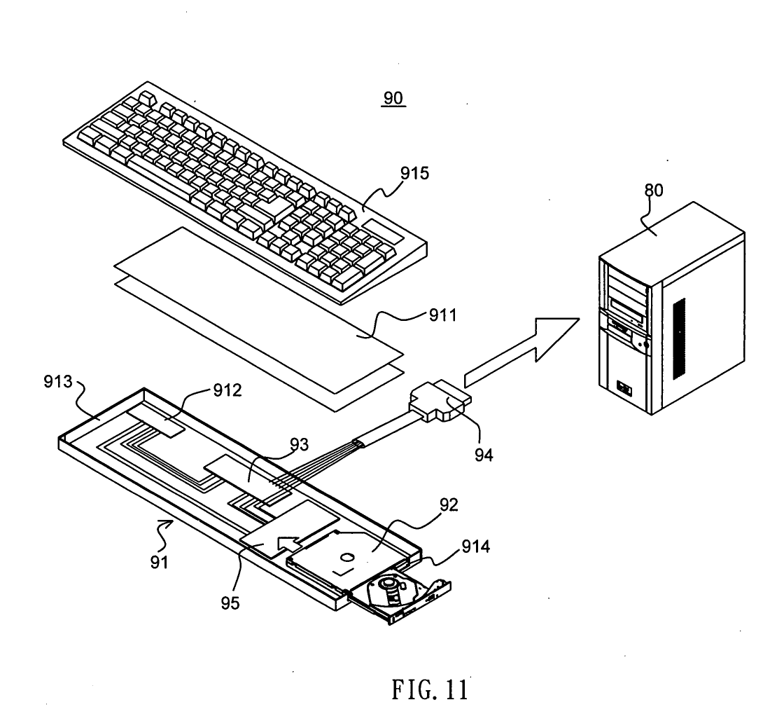

Referring to FIGS. 10 and 11, a further embodiment of the ergonomic component 90, which integrates the keyboard 91 and laptop optical drive 92, is illustrated. The ergonomic component 90 has an IEEE1394 interface concentrator 93 to electrically connect with the keyboard 91 and laptop optical drive 92. An IEEE1394 interface connector 94 electrically connects the IEEE1394 interface concentrator 93 and the IEEE1394 interface concentrator 81 of a system housing 80. In this way, message transmission between the system housing 80 and the keyboard 91 and between the system house 80 and the laptop type optical drive 92. The IEEE1394 interface concentrator 81 electrically connects with the main board 82. The IEEE1394 interface has six transmission lines, which includes four signal lines and two power lines. The signal lines have a transmission rate of 400 Mbps and it is sufficient for offering 10.9 Mps frequency width needed by the optical drive 92 and the keyboard 91 together. The two power source lines are capable of transmitting power with 8˜40V/1.5A for power 5V/1.5A needed by the optical drive and 5V/01A needed by the keyboard after properly power transfer with power regulator.

Because transmission interface of the laptop optical drive 92 is IDE and only requires voltage of 5V, it is necessary to electrically connect with the IEEE1394 interface concentrator 93 via a circuit board 95 with a converting circuit for changing the IDE interface into IEEE1394 interface and reducing the voltage to 5V. Similarly, the keyboard 91 has to provide a circuit board 912 with IEEE1394 interface in addition to the conventional keyboard circuit board 911.

The circuit boards 95, 912 electrically connect with the IEEE1394 interface concentrator 93 via a transmission line respectively to congregate as a single IEEE1394 transmission line to connect with the IEEE1394 interface of the system housing 80 via the IEEE1394 interface connector 94. The laptop optical drive 92, the circuit board 95 and the IEEE1394 interface concentrator 93 and the transmission line are received in the base 913. The base 913 has an opening 914 at a lateral side thereof available for a holding tray of the notebook type optical drive 92 moving in or out for the compact disk being able to be loaded in the notebook type optical drive 92. The keyboard 91 has an upper cover 915 with a plurality of press keys being joined to circuit board of the keyboard and being attached to the top of the base 913.

All the components of the computer system in the Taiwanese Utility Model No. M240597 are received in the keyboard except the monitor, that is, the volume of the keyboard is increased for receiving all the components. The greatest difference of the present invention from the prior art is concept of screen. For reducing space occupied by the computer system in the operational zone, the present invention is completely different from the prior art and the system housing is removed from the operational zone completely based on concept of the present invention. All the components being stuffed in a limited small space in the prior art with less heat dissipation makes expansion of hardware almost impossible and it results in performance of the computer is seriously restricted. The system housing moves out the operational zone in the present invention so that the major space design is unlimited and advantages such as performance of hardware capable of promoting and expanding without restriction.

It is appreciated that product of computer peripheral designed based on ergonomics and fabricating method thereof according to the present invention integrates the keyboard and the optical drive or the card reader as a new product to allow the components touched by the user being integrated by means of ergonomics and size factor. Hence, the present invention has the following advantages:

Space for the system housing of a computer is able to be designed flexible without being limited with operation space of human body such as area of the desktop without problem of sacrificing performance of the computer due to decreasing size of the main board and space of heat dissipation.

The user can operate conveniently such that message transmission between the peripheral and the computer can be performed without moving the body of the user.

The user can arrange space on the work platform more flexibly to eliminate requirement of the system housing being placed on the desktop.

While the invention has been described with referencing to preferred embodiments thereof, it is to be understood that modifications or variations may be easily made without departing from the spirit of this invention, which is defined by the appended claims.

What is claimed is:

1. A method for fabricating a product of computer peripheral based on ergonomic design, comprising following steps:
(1) screening all components of an entire computer;
(2) affirming the components if there is a need of ergonomic interface? if it is necessary being close to an area for an user being able to reach conveniently? and if it is capable of reducing a space on a work platform being occupied effectively after different components are integrated? and screening a portable storage media device and a keyboard according to the preceding criterion; and
(3) integrating the portable storage media device and the keyboard as an integral body.

2. The method for fabricating a product of computer peripheral based on ergonomic design as defined in claim 1, wherein a system house is excluded based on the criterion with regard to “if there is a need of ergonomic interface” stated in step 2.

3. The method for fabricating a product of computer peripheral based on ergonomic design as defined in claim 1, wherein a monitor and loud speakers are excluded based on the criterion with regard to “if it is necessary being close to an area for an user being able to reach conveniently?” stated in step 2.

4. The method for fabricating a product of computer peripheral based on ergonomic design as defined in claim 1, wherein a mouse is excluded based on the criterion with regard to “if it is capable of reducing a space on a work platform being occupied effectively after different components are integrated?” stated in step 2.

5. The method for fabricating a product of computer peripheral based on ergonomic design as defined in claim 1, wherein the space on the work platform being occupied stated in step 2 means an area on on the work platform being occupied.

6. The method for fabricating a product of computer peripheral based on ergonomic design as defined in claim 1, wherein the portable storage media device refers to one of compact disk drive, card reader and floppy disk.

7. A product of computer peripheral designed based on ergonomics, being made by means of the method defined in claim 1 and being electrically connected to the system house for performing message transmission, comprising:
a keyboard, providing a base with an opening being joined to an upper cover, which has a plurality of press keys; and
a portable storage media device, being mounted in the base for being inserted with storage media via the opening;
wherein, the portable storage media device and keyboard have a transmission interface for electrically connecting with a system house via a transmission line and a transmission interface connector respectively.

8. The product of computer peripheral designed based on ergonomics as defined in claim 7, wherein a circuit integrated module is associated with interior of the base with the transmission interface of the keyboard and the transmission interface of the portable storage media device electrically connecting with the circuit integrated module via a further transmission line respectively for the circuit integrated module being electrically connected to the system house via a further transmission line and a further transmission interface connector.

9. The product of computer peripheral designed based on ergonomics as defined in claim 8, wherein the circuit integrated module is an IEEE1394 interface concentrator.

10. The product of computer peripheral designed based on ergonomics as defined in claim 9, wherein a circuit board with a converting circuit is joined to the interior of the base and the circuit board connects with the IEEE1394 interface concentrator via a further transmission line such that the transmission interface of the portable storage device is converted to IEEE1394 interface and voltage of the IEEE1394 interface is reduced to a value suitable for the portable storage media device.

11. The product of computer peripheral designed based on ergonomics as defined in claim 10, wherein the keyboard has a circuit board with IEEE1394 interface concentrator.

12. The product of computer peripheral designed based on ergonomics as defined in claim 11, wherein the portable storage device is a notebook type optical drive with IDE transmission interface.
